(19) United States
(12) Patent Application Publication
(10) Pub. No.: US 2016/0198199 A1
(43) Pub. Date: Jul. 7, 2016

(54) METHOD AND APPARATUS FOR CONTROLLING STREAMING OF VIDEO CONTENT

(71) Applicant: TELEFONAKTEBOLAGET L M ERICSSON (PUBL), Stockholm (SE)

(72) Inventors: Giulio BOTTARI, Pisa (IT); Diego CAVIGLIA, Stockholm (SE); Daniele CECCARELLI, Stockholm (SE)

(21) Appl. No.: 14/909,442

(22) PCT Filed: Aug. 1, 2013
(86) PCT No.: PCT/EP2013/066191

§ 371 Date: Feb. 1, 2016

(51) Int. Cl. H04N 21/234; H04N 21/44; H04N 21/442; H04N 21/24

(52) U.S. Cl. CPC H04N 21/23406; H04N 21/2402; H04N 21/44004; H04N 21/44209

(57) ABSTRACT

A method for controlling streaming of video content delivered over a communications network. The method comprises setting a transfer threshold of at least one buffer involved in delivery of the streamed video content based upon expected delays in the communications network, wherein the transfer threshold comprises a minimum amount of data to be contained in the buffer before data is forwarded from the buffer. Also provided are an apparatus and a computer program product configured to control streaming of video content delivered over the communications network.

### TECHNICAL FIELD

The present invention relates to a method and an apparatus for controlling streaming of video content. The present invention also relates to a computer program product configured, when run on a computer, to carry out a method for controlling streaming of video content.

### BACKGROUND

Video streaming is used for leisure and business purposes to view video content over a communication network or networks. In contrast to downloading video media for playback, streaming involves the continuous playback of video content as it arrives at the end user apparatus, significantly shortening waiting times and, when all proceeds well, providing a generally satisfactory user experience.

Owing to the best effort nature of communication across distributed network systems such as the Internet, it is necessary to account for minor interruptions to the stream of data supplying the video content. In order to address this issue, a local client buffer is used to “pre-download” a portion of the video content before playback is started. This buffer may then be used to cushion the effect of interruptions in the data stream, such that the end user does not experience an interruption of video playback as a result of an interruption in the arrival of the streamed content. This buffering procedure is also conducted at various intermediate network elements involved in the delivery of the video content from a data server to the end user.

FIG. 1 illustrates how the buffering process at a video client may be represented to the end user. The video content is displayed on a screen 2, on which a progress bar 4 represents the video segment to be streamed. A first section 6 of the progress bar, between points A and B, represents video content that has already been viewed. A second section 8 of the progress bar, between points B and C, represents the contents of the client buffer, i.e. the portion of pre-downloaded video present in the client buffer at the time. A third section 10 of the progress bar, between points C and D represents that portion of the video segment that has not yet been received at the video client. The size of the second segment 8 may change, for example increasing in size in fast networks where the rate of data arrival is greater than the playback rate. In contrast, if data arrival at the buffer is interrupted while playback continues as normal, the segment 8 may reduce in size. When the second segment 8 becomes very small, representing an almost empty client buffer, video playback will pause owing to the lack of streaming data.

As noted above, when all the resources involved in delivery of streaming data are functioning well, streaming using a client buffer can provide a satisfactory user experience. However, various issues can contribute to playback interruptions and a reduced quality of experience. In some instances, the initial time to pre-download video before starting playback can be unacceptably long. In others, the buffer contents may be insufficient to compensate for interruptions or delays in the arrival of streaming data, and video playback interruptions can result. Packet loss on the network delivering the streaming data can also contribute to poor user experience. A percentage of packets are typically lost during transmission of streaming data over a network. This may be a consequence of insufficient bandwidth somewhere in the end to end connection, overload or congestion of routers managing the video flow or a failure affecting the end to end connection and which has not yet been recovered. Packet loss forces packet re-transmission and thus causes additional delay. Consequently, over a certain percentage, packet loss may adversely affect video playback at the end user.

The potential for interruptions to data streaming services may be appreciated from consideration of a practical example of a video streaming scenario such as an end user playing a streamed video on a tablet computer. Originating at a video server, the video content may be delivered using a stack of IP carried in MPLS tunnels over an optical physical layer framed with OTN in the metro area, using MPLS-TP over Ethernet in the mobile backhaul area, and using IP over Ethernet over microwave in the radio access area. Finally, the tablet computer may connect to the network via LTE broadband access. An issue in any one of the network segments involved in delivery of the content may cause an interruption in video playback, and so adversely affect the end user's quality of experience.

### SUMMARY

It is an aim of the present invention to provide a method and apparatus which obviate or reduce at least one or more of the disadvantages mentioned above.

According to an aspect of the present invention, there is provided a method for controlling streaming of video content delivered over a communications network, the method comprising setting a transfer threshold of at least one buffer involved in delivery of the streamed video content based upon expected delays in the communications network. The transfer threshold comprises a minimum amount of data to be contained in the buffer before data is forwarded from the buffer.

Aspects of the present invention provide improved buffering efficiency, tailoring the threshold at which data is forwarded from the buffer to the network conditions, as represented by the expected delays in the communications network. The at least one buffer may be a client buffer, a buffer at a proxy server or may serve any other network element involved in the delivery of the video content. The buffer may be realised in hardware or software. By setting the transfer threshold based upon expected delays in the communications network, aspects of the invention may allow for shorter delay times in fast networks enjoying minimal delays, and may also contribute to fewer interruptions for streamed video content delivered over slower networks or those experiencing high delay levels for example owing to congestion, inadequate resourcing, unrecovered failures etc.

According to embodiments of the invention, setting a transfer threshold based on expected delays in the communications network may comprise receiving an indication of expected network delay and setting the transfer threshold based upon the received indication.

According to embodiments of the invention, setting the transfer threshold based upon the received indication may comprise setting the transfer threshold to be an amount of data corresponding to a video content playback duration at least equal to the indicated expected network delay.

In this manner, embodiments of the invention may expect to ensure largely uninterrupted playback in the current network conditions. The amount of data required to cover a particular delay may vary according to the encoding and quality of the video stream concerned, high definition (HD) video for example requiring a greater amount of data to cover a given delay than standard definition (SD) video.

According to embodiments of the invention, receiving an indication may comprise receiving a parameter representative of an expected network delay. Such a parameter may for example be stored and manipulated to enable calculation of the appropriate transfer threshold for the at least one buffer. In other examples, the indication may for example comprise a reference to one of a standard or predefined class of delay categories or network condition categories. For example, receiving an indication of expected delay may comprise receiving an indication that current network delay is within normal limits, is lower than normal limits, is consistent with mild or heavy network congestion etc. An appropriate transfer threshold for the different classes may be defined and programmed in the appropriate network elements.

According to embodiments of the invention, the video content may be delivered over a path through the network, and the parameter may be representative of an expected network delay over the path.

According to such embodiments, the parameter may therefore be representative not only of global network conditions but of the specific conditions that will be experienced by streamed video content being delivered to a particular user. The parameter may thus be as accurate as possible in representing expected network delay for the streamed video content. In some examples, the path through the network may be established between a video server and an end user on receipt of a demand for streamed video from the end user. The expected delay over the path may be established as soon as the path itself is established, as establishing the path involves designating all of the network resources (elements and links) involved in the path.

In some examples, the expected network delay over the path may be an expected end to end network delay over the path. In other examples, the expected network delay over the path may be a network delay over a segment of the end to end path, for example when the path involves several different network operators.

According to embodiments of the invention, the parameter may be representative of an expected network transmission delay.

According to further embodiments of the invention, the parameter may also be representative of an expected recovery delay in the event of a network resource failure.

In some examples, the parameter may comprise a summation of a first element representative of an expected network transmission delay and a second element representative of an expected recovery delay in the event of a network resource failure.

According to embodiments of the invention, receiving an indication of expected network delay may comprise receiving a first parameter representative of an expected network transmission delay and a second parameter representative of an expected network transmission delay and an expected recovery delay.

According to embodiments of the invention, setting the transfer threshold based upon the received indication may comprise setting the transfer threshold based on at least one of the first or second parameters. According to such examples, a choice may be made as to which parameter should form the basis of the setting of the transfer threshold. In some examples, such a choice may be made by an end user, for example if the at least one buffer serves a video client. In other examples, the choice may be made by a network operator, for example if the at least one buffer serves an intermediate element such as a proxy server.

According to embodiments of the invention, receiving an indication of expected network delay may further comprise receiving a parameter representative of network packet loss. The method may further comprise adjusting the transfer threshold according to the received packet loss parameter. According to such embodiments, the transfer threshold may be tailored to a likely deterioration in network conditions, as indicated for example by a high percentage packet loss. In addition, allowance may be made for a likely increasing delay, as packet loss triggers packet re-transmission and so is likely to increase the transmission delay in the network. In many networks a parameter representative of network packet loss is readily available and so may be used for refining the transfer threshold according to embodiments of the present invention without placing significant additional burden on the network to provide this information.

According to embodiments of the invention, the method may further comprise receiving an updated indication of expected network delay and updating the transfer threshold according to the updated indication. In some examples, updating of the transfer threshold may be performed periodically over time periods which may be set by a network operator for example according to rates of change of network conditions.

According to embodiments of the invention, the at least one buffer may comprise a client buffer at an end user.

According to embodiments of the invention, the at least one buffer may comprise a proxy server buffer in the communications network. The proxy server may in some examples be a TCP proxy or HTTP proxy.

According to various examples, the at least one buffer may be implemented in software or in hardware.

According to another aspect of the present invention, there is provided a method for controlling streaming of video content delivered over a communications network, the method comprising receiving a request from a network user for streamed video content and sending an indication of expected network delays to at least one network element involved in delivery of the video content, wherein the network element comprises a buffer. The network element may in some examples be a video client at the network user, a proxy server or any other element comprising a buffer and involved in delivery of the video content.

According to embodiments of the invention, the method may further comprise establishing a path from the end user to a video server hosting the video content, establishing a parameter representative of expected network delays over the established path and sending the parameter to the at least one network element, wherein the at least one network element is comprised within the established network path. According to some embodiments, the parameter may be established and sent as soon as or shortly after the path has been established. In this manner it may be possible to allow for the appropriate transfer threshold to be set in good time for the start of delivery of the content.

According to embodiments of the invention, the network element may comprise a client device at the end user.

According to embodiments of the invention, the network element may comprise a proxy server.

According to a further aspect of the present invention, there is provided a computer program product configured, when run on a computer, to carry out a method according to the first or second aspects of the present invention. Examples of the computer program product may be incorporated into an apparatus such as a user equipment device which may be configured to display streamed video content. Alternatively, examples of the computer program product may be incorporated into a network element involved in delivery of streamed video content. The computer program product may be stored on a computer-readable medium, or it could, for example, be in the form of a signal such as a downloadable data signal, or it could be in any other form. Some or all of the computer program product may be made available via download from the internet.

According to another aspect of the present invention, there is provided an apparatus for controlling streaming of video content delivered over a communications network, the apparatus comprising a setting unit configured to set a transfer threshold of at least one buffer involved in delivery of the streamed video content based upon expected delays in the communications network. The transfer threshold comprises a minimum amount of data to be contained in the buffer before data is forwarded from the buffer.

According to some examples, the units of the apparatus may be functional units which may be realised in any combination of hardware and/or software.

According to embodiments of the invention, the setting unit may comprise a receiving unit which may be configured to receive an indication of expected network delay, and a threshold unit which may be configured to set the transfer threshold based upon the received indication.

According to embodiments of the invention, the setting unit may further comprise an adjusting unit which may be configured to adjust the transfer threshold according to a received packet loss parameter.

According to embodiments of the invention, the setting unit may further comprise an updating unit which may be configured to update the transfer threshold according to a received updated indication of expected network delay.

### BRIEF DESCRIPTION OF THE DRAWINGS

For a better understanding of the present invention, and to show more clearly how it may be carried into effect, reference will now be made, by way of example, to the following drawings in which:

FIG. 1 illustrates the appearance to an end user of a buffering function in a video client;

FIG. 2 is a flow chart illustrating process steps in a method for controlling streaming of video content;

FIG. 3 is a schematic representation of elements involved in streaming of video content;

FIG. 4 is a flow chart illustrating process steps in another method for controlling streaming of video content.

FIG. 5 is a flow chart illustrating process steps in another method for controlling streaming of video content.

FIG. 6 is a block diagram illustrating functional units in an apparatus for controlling streaming of video content.

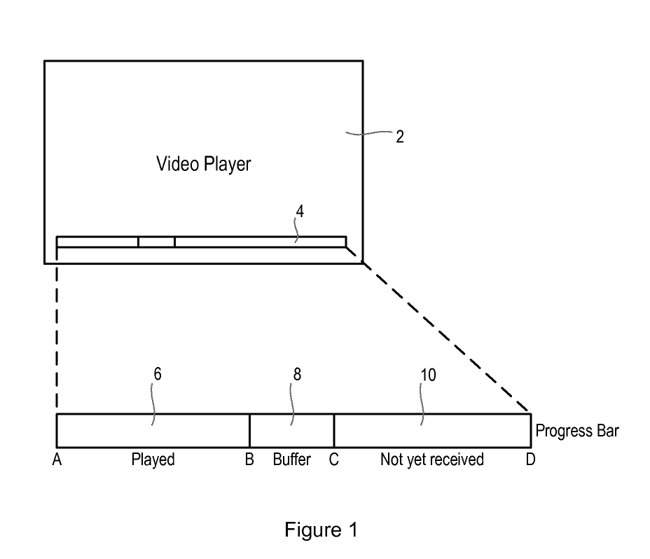

### DETAILED DESCRIPTION

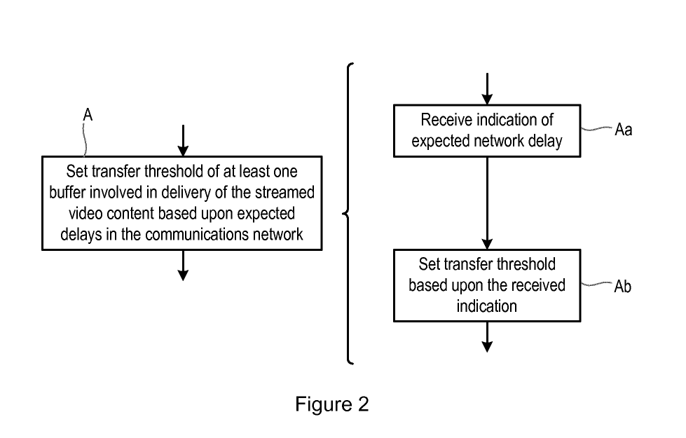

Aspects of the present invention provide methods for controlling streaming of video content. FIG. 2 is a flow chart illustrating process steps in such a method 100. With reference to FIG. 2, the method 100 comprises the step A of setting a transfer threshold of at least one buffer involved in delivery of the streamed video content based upon expected delays in the communications network. The transfer threshold of the at least one buffer comprises a minimum amount of data to be contained in the buffer before data is forwarded from the buffer. The buffer may for example serve a video client at the end user or may be comprised within another network element such as a proxy server.

As illustrated in FIG. 2, the step A of the method 100 may be achieved by receiving, at sub-step Aa, an indication of expected network delay, and setting, at sub step Ab, the transfer threshold based on the received indication. The indication may for example comprise a reference to one of a standard or predefined class of delay categories or network condition categories. For example, receiving an indication of expected delay may comprise receiving an indication that current network delay is within normal limits, is lower than normal limits, is consistent with mild or heavy network congestion etc. An appropriate transfer threshold for the different classes may be defined and programmed in the appropriate network elements. In this manner, a network operator may keep confidential the precise details of delay performance and other potentially sensitive network data, while still improving user quality of experience through the application of pre programmed transfer thresholds appropriate to the different classes. In other examples, as discussed more fully below, the indication may include a parameter representative of network delay.

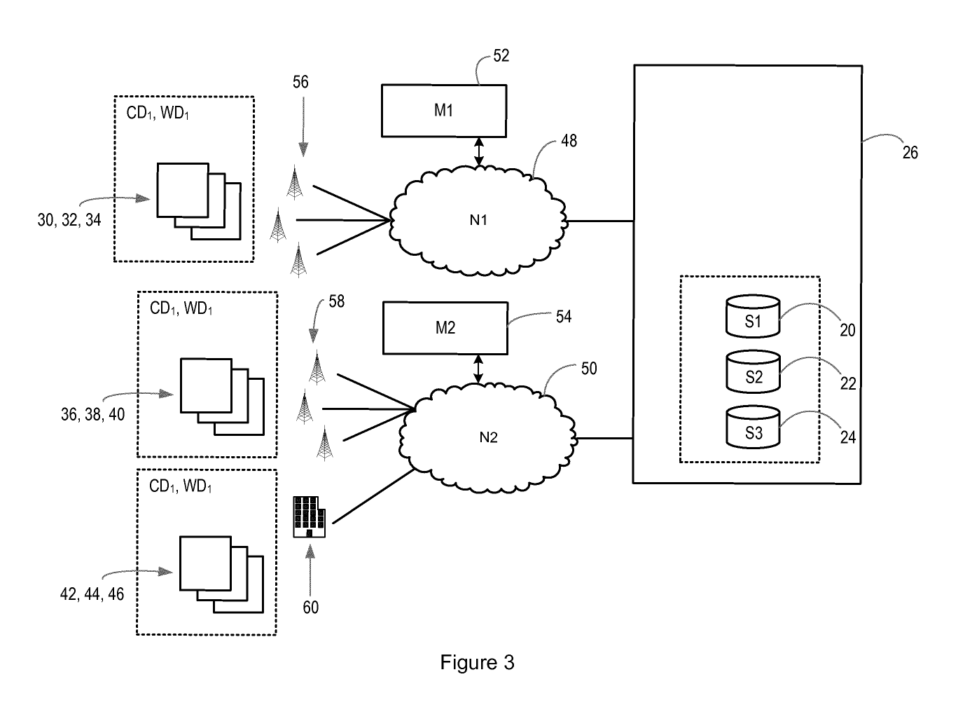

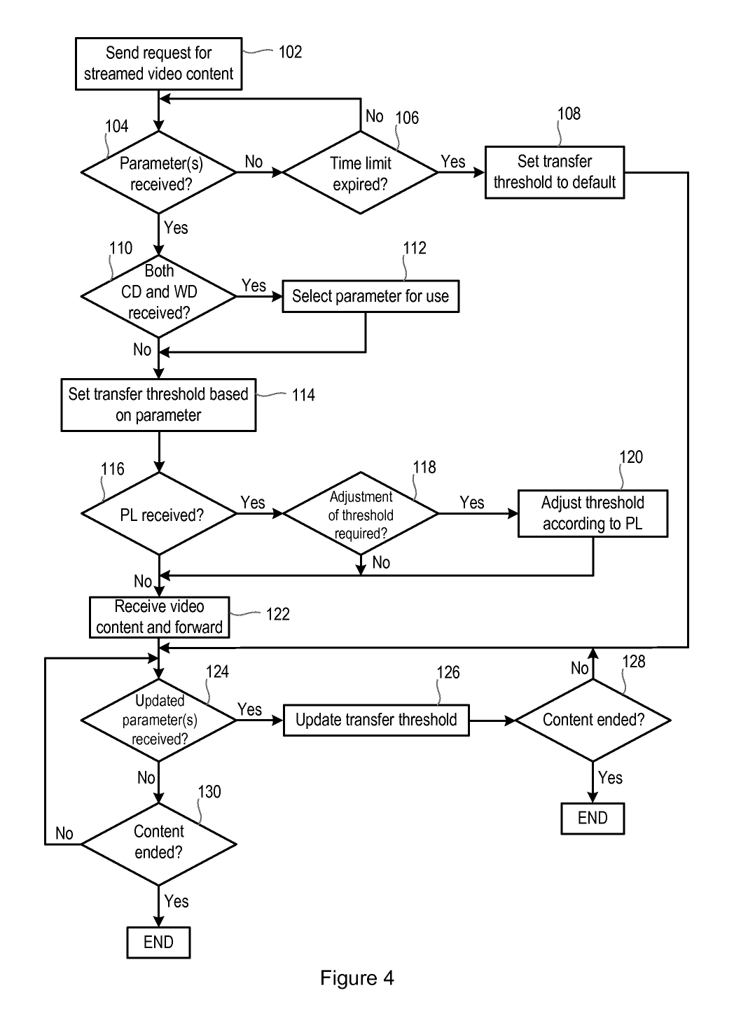

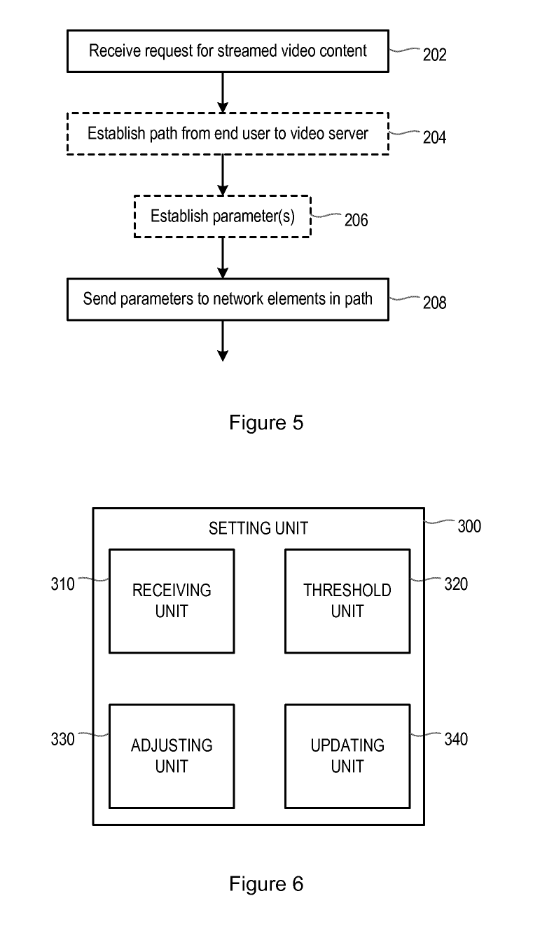

FIGS. 4 and 5 illustrate one way in which the step A of the method 100 may be achieved, illustrating actions that may be taken at network elements, including for example a video client and a proxy server and at a network controller. The steps in FIGS. 4 and 5 are explained in detail below, referring also to the simplified example scenario illustrated in FIG. 3.

Video streaming data is typically supplied to end users over a content delivery network (CDN), which is a large distributed system of servers deployed in multiple data centres across the Internet. A CDN aims to deliver content to end users with high availability and high performance. CDNs serve a significant fraction of current Internet traffic, including live streaming media and on-demand streaming media.

FIG. 3 illustrates a simplified scenario involving delivery of video content from video servers 20, 22, 24 in a data centre 26 to video clients 30, 32, 34, 36, 38, 40, 42, 44 and 46. The data centre 26 is connected to two networks 48, 50, each having a corresponding management system 52, 54. A control plane and/or software defined network (SDN) scenario may also be envisaged but is not illustrated in the Figure. The first network 48 is connected to a mobile front-haul 56 which provides wireless broadband coverage. The second network 50 is connected both to a mobile front-haul 58 and to a wired residential access segment 60, for example with DSLAMs over copper.

The clients 30 to 46 connect to the servers 20, 22, 24 over the networks 48, 50. For example, client 30 may receive video streaming from server 24 via network 48, while client 42 receives video streaming from server 24 via network 50. Although clients 30 and 42 may be in a peer to peer relation with the same server 24, they experience different network delays and may be subject to different traffic outages in case of failure, owing to the different paths over which the streaming data is delivered. Even if the same network were used, different delays and potential outages would likely still be experienced, owing to the many different paths via which streaming data may cross a single network.

In order to characterise network conditions that may influence the delivery of streaming data, embodiments of the present invention introduce the following parameters:

Current Delay (CD) is defined as the delay that a transmission between a particular video server and a particular video client is experiencing at the present time. The CD may depend upon several different factors, which independently and cumulatively may affect CD. The CD may be affected by factors within the core network as well as within the access segment of the network, and may evolve over time. CD may be estimated based on measurements received from the relevant network resources operating in their normal manner.

Worst Case Delay (WD) is defined as the Current Delay (CD) plus the maximum estimated traffic outage in the case of a resource (element or link) failure affecting the transmission. The maximum estimated traffic outage corresponds to the maximum amount of time that would be required to effect a recovery action in the event of a failure. This action may involve moving the traffic to an alternative path or any other appropriate recovery action that restores the transmission. The maximum time for a recovery action corresponds to the slowest recovery time amongst all the network layers involved in the transmission and among all the network segments which may be included in the path between video server and video client. In an idealised case, all resources involved in the transmission of streaming data may be protected with a 1+1 protection scheme, according to which traffic is recovered in a limited time frame of the order of, for example, 50 ms. In such cases, and using this example, the maximum estimated traffic outage may be equal to 50 ms, which may be negligible compared to the Current Delay, CD, meaning that WD≈CD.

Packet Loss (PL) is defined as the percentage of packets currently being lost during transmissions. Packet loss may be caused for example by signal degradation over the network medium due to multi-path fading, packet drop because of channel congestion, corrupted packets rejected in-transit, faulty networking hardware, faulty network drivers or normal routing routines. When caused by network problems, lost or dropped packets can result in highly noticeable performance issues or jitter with streaming technologies. Packet Loss PL is a comparatively simple parameter to extract, being automatically provided by network routers.

Referring now to FIG. 4, actions taken at a network element when implementing a method according to embodiments of the present invention are described. The following description illustrates the invention with reference to actions taken at a video client; however, corresponding actions may also be taken at other network elements, including proxy servers, as discussed in further detail below.

In a first step 102, the video client sends a request for streamed video content. This request may be triggered for example by an end user clicking on a link to streamed video content, or pressing play on a particular segment of streamed video. The request is sent over the network to which the user apparatus running the video client is connected. The video client then checks, at step 104, for receipt of a parameter or parameters from the network. If a parameter or parameters have not been received (No at step 104), the video client checks for expiry of a time limit at step 106, and if the time limit has not expired (No at step 106) the video client returns to step 104 and continues to check for receipt of the parameters. If at step 106 the video client discovers that the time limit has expired (Yes at step 106), the video client proceeds to set the transfer threshold of its buffer to a default setting at step 108. In such circumstances, it may be assumed that the parameters will not be received and hence a transfer threshold should be set according to default operating conditions in order to allow proper functioning of the buffer. After setting the transfer threshold according to default conditions, the video client may continue to check for receipt of the parameters by proceeding directly to step 124, in which a check for updated parameters is made. The video client may thus follow the update procedure discussed in further detail below in order to replace a default transfer threshold with a parameter based transfer threshold if and when a suitable parameter is received.

As discussed above, a transfer threshold is the minimum amount of data to be contained in the buffer before data is forwarded from the buffer. In the case of a client buffer serving a video client, forwarding data from the buffer involves forwarding the data for video playback. In other buffers such as proxy buffers, data may be forwarded to the next network element in the transmission path.

Once it is determined at step 104 that at least one parameter has been received (Yes at step 104), the video client proceeds to determine whether both of CD and WD have been received, or whether only one or other of CD and WD have been received. If both CD and WD have been received (Yes at step 110), the video client proceeds at step 112 to select which of the received parameters CD and WD should be used for the subsequent setting of the transfer threshold. The basis on which a selection may be made between CD and WD is discussed in further detail below. If only one of CD or WD has been received, there is no need to make a selection, and the video client proceeds to the setting step 114. Once a parameter has been selected, if necessary, the video client proceeds to set the transfer threshold of its buffer based on the parameter. According to the present embodiment, this involves setting the transfer threshold as an amount of data sufficient to enable video playback for a duration of time equal to the selected or received parameter (CD or WD). For example, if the appropriate parameter has a value of 2 seconds, the video client sets the transfer threshold as an amount of data corresponding to 2 seconds worth of video playback. The amount of data required to support a given playback duration will depend upon the nature and encoding of the video content. For example, high definition video requires a far greater amount of data than standard video. The video client may calculate the appropriate amount of data based upon the nature and encoding of the video segment to be streamed.

It can be seen from the above discussion that the CD and WD offer different advantages as a basis for setting of the transfer threshold. Using CD will result in a lower transfer threshold than using WD, as CD represents only the current delay, and not the worst case delay. A CD based transfer threshold therefore results in shorter waiting times for initial playback start up (the time during which the buffer is initially filled to the transfer threshold). However, CD only offers protection from interruption corresponding to current network conditions. CD thus offers a compromise between protecting against expected delays while maintaining shorter start up times. In contrast, WD, by allowing both for current delays and recovery from a resource failure, offers increased certainty in continuity of playback at the price of a longer start up time while the buffer initially fills to a higher threshold. It may be noted that interruption to video playback may still occur, even with a WD based transfer threshold, in the rare event that the network suffers a failure of multiple resource elements in the delivery path of the streaming data. Such multiple resource failure are not common, and thus the protection afforded by WD, against current network delay and the worst case single element failure, offers a high degree of certainty for continuity of video playback.

In some cases, a network operator may choose not to provide the parameter WD, and only to provide CD. The reasons for this are discussed more fully below in connection with FIG. 5. In such cases, only CD is provided and the user does not have a selection to make as to the basis to be used for setting the transfer threshold. In other examples, both CD and WD may be provided to the video client, and the video client or end user may select which of CD or WD should be used to set the transfer threshold. It may be the case that for leisure activity, a CD based threshold is preferable, providing shorter start up times for content for which the user is prepared to accept a minor risk of interruption. In contrast, a user may select a WD based transfer threshold for business related use, where a slightly longer start up time is deemed an acceptable inconvenience to be assured of interruption free playback, even in the event of a resource failure in the transmission path. An example of such use would be surveillance cameras continuously streaming video from a surveillance location to a remote central office or monitoring station. Fuel service stations or retail outlets which may be closed during the night and not have on site security personnel might be monitored in such a way, allowing intervention by remotely based surveillance personnel in case of incident. In such situations, a longer start up time would be an acceptable inconvenience to secure interruption free playback.

It will be appreciated that an upper limit may be placed on the transfer threshold of the buffer. A size of the buffer provides a hard ceiling for the transfer threshold, but a pre-programmed upper limit, below the maximum size of the buffer, may also be defined and applied if desired by an end user or a network operator.

Returning to FIG. 4, once the transfer threshold has been set based on the received/selected parameter at step 114, the video client proceeds to check for receipt of the parameter PL at step 116. If PL has not been received, the video client simply proceeds to receive video content in its buffer and forward content from the buffer (to video playback) at step 122 in accordance with the set transfer threshold. If the parameter PL has been received (Yes at step 116), the video client checks at step 118 whether or not adjustment of the set transfer threshold is required on the basis of this parameter. As discussed above, a high percentage packet loss is an indication of potential problems in the data path. High packet loss also results in high levels of packet resending, resulting in increased network congestion, and providing a strong indication that the network transmission delay is likely to increase. A high or increasing PL may therefore be used as an indication that the transfer threshold should be adjusted upwards to account for a likely increase in transmission delay. Thus if the transfer threshold has been set at step 114 as data for a 2 second video playback, and a high PL is received, the video client may determine at step 118 that adjustment of the threshold is required, and may proceed at step 120 to adjust the threshold, for example increasing it to 2.5 seconds of video playback.

Having adjusted the transfer threshold if deemed required, the video client then proceeds to step 122, receiving video data in the buffer and forwarding it from the buffer for playback once the transfer threshold has been reached.

The video client may then check for receipt of an updated parameter or parameters in step 124. Updated parameters may be provided on a periodic basis by the network, with the time period set in accordance with likely rates of change of underlying network conditions. The time period may for example be of the order of between 1 and 4 hours. Issues affecting network delay, such as traffic congestion, tend to change over a time scale of hours rather than minutes or seconds, corresponding for example to peak evening hours of activity, or to large public events. Thus for a short video segment of several minutes, no updated parameters may be received and the method may simply exit once it is determined at step 130 that playback of the video content has ended. If the video segment is longer, lasting for example several hours, updated parameters may be received (Yes at step 124), in which case the video client proceeds to update the transfer threshold according to the newly received parameters before checking for the end of the video content at step 128 and exiting accordingly.

The steps of FIG. 4 have been described with reference to actions taken at a video client, but it will be appreciated that corresponding steps may be taken at other network elements, including for example proxy servers involved in the delivery of the video content. TCP (transmission Control Protocol) is widely used in commercial multimedia streaming systems, and a significant proportion of current internet streaming media is delivered over HTTP/TCP. An HTTP/TCP proxy server is thus another example of a network element in which the method described above with respect to FIG. 4 may run. In such elements, data is forwarded from the buffer to the next network element in the delivery path for the particular video content. TCP is controlled by the network management, and thus a decision as to whether to use CD or WD, if both are received, for the setting of the transfer threshold may be made at the network management level. A single TCP proxy server and associated buffer may serve up to many thousands of clients, and for simplicity it may therefore be desirable to set the transfer threshold of the buffer based on WD, so ensuring maximum certainty for continuity of playback. In other examples, CD or WD may be used according to the level of service to which a particular end user has subscribed.

FIG. 5 illustrates steps which may take place at a network management. The steps 202 to 208 of FIG. 5 may be conducted in the network management between the steps 102 and 104 of the method of FIG. 4.

Referring to FIG. 5, in a first step 202, the network management receives a request for streamed video content from an end user using a video client. The network management then establishes a path in step 204, extending from the video client of the end user to the video server hosting the requested data. The network path defines the network resources (elements and links) that will transmit the data through the network to the end user. Having established the path, the network management is then in a position to establish, at step 206, the delay parameter or parameters to be sent to network elements within the path. As discussed above, the parameters may include CD, WD and PL. It may be the case that only one or some of these parameters is established for future sending. Alternatively, all of the parameters may be established with all or only one or some of the parameters being sent to certain network elements.

The parameter PL may be established from reported packet loss information received from network elements in the established flow path. Similarly, the Current Delay CD may be assembled from measurements received from elements in the flow path. The Worst Case Delay WD may be assembled by adding to the established CD the slowest recovery time for a resource in the established path.

In many cases the established parameters will relate to the complete end to end path from the video server to the end user. However, in some cases, an end to end path may involve several different networks, and no one network management entity may have visibility of the full end to end path. For example, in cases of an end user located on a different continent to a video server hosting the requested data, different national and international entities may be responsible for different segments of the path from server to end user. In such cases, each operator may have control and visibility of a part of the delay, and may establish parameters and forward them to appropriate network entities. In some examples, all parameters may be forwarded for example to an end user apparatus, at which an end to end delay may be calculated as the sum of the individual segment delays.

Once established, one or more of the parameters may be sent by the network management to network elements in the established path. These elements may include the video client at the end user as well as proxy servers such as HTTP/TCP servers. The network management may elect to send certain parameters to some network elements but not to others. For example, the parameter WD provides an indication of the resiliency of the network, and therefore represents potentially commercially sensitive network information. A network operator may choose not to make such information available to all end users who may connect to the network. It may therefore be the case that CD is provided to end users as a default arrangement, and only certain customers who pay for a higher level of service are also provided with WD, allowing the option of choosing which of CD and WD should be used for the setting of the transfer threshold. In contrast, all available parameters may be sent to intermediate elements such as proxy servers, which are also controlled by the network management. As discussed above, the network management may use one or other of CD or WD as the default basis for transfer threshold setting, or may use different parameters for different customers, depending upon the level of service to which they have subscribed.

Apparatus for conducting the methods described above, for example on receipt of suitable computer readable instructions, may be incorporated within network elements and/or network management. FIG. 6 illustrates functional units in a setting unit 300 which may execute the steps of the method of FIG. 4, for example according to computer readable instructions received from a computer program. The setting unit 300 may for example comprise a processor. The setting unit 300 comprises a receiving unit 310, a threshold unit 320, an adjusting unit 330 and an updating unit 340. It will be understood that the units are functional units, and may be realised in any appropriate combination of hardware and/or software.

The setting unit 300 may be configured to set a transfer threshold of at least one buffer associated with the unit, and may be configured to set the transfer threshold in accordance with a received indication of network delay. The receiving unit 310 may be configured to receive an indication of expected network delay, which may be in the form of parameters including CD, WD and PL, representative of network delay. The threshold unit 320 may be configured to set the transfer threshold based upon the received indication. The adjusting unit 320 may be configured to adjust the set transfer threshold according to a received packet loss parameter. The updating unit may be configured to update the transfer threshold according to a received updated indication of expected network delay.

The above described embodiments illustrate how aspects of the present invention provide improved buffering efficiency by setting a transfer threshold of at least one buffer involved in delivery of streamed video content based on expected network delays. By correlating the transfer threshold to network conditions, the transfer threshold may be set at a level appropriate to ensure improved continuity of playback for the minimum start up delay. Aspects of the invention thus focus on improving the quality of experience for the end user through the matching of transfer threshold to network conditions. It is an advantage of aspects of the present invention that they are suitable for use in software defined network architecture as well as being backwards compatible with older video clients or network elements. Older elements may simply ignore the received indication of expected network delay and continue to operate in a conventional manner.

It should be noted that the above-mentioned examples illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for controlling streaming of video content delivered over a communications network, comprising:
setting a transfer threshold of at least one buffer involved in delivery of the streamed video content based upon expected delays in the communications network;
wherein the transfer threshold comprises a minimum amount of data to be contained in the at least one buffer before data is forwarded from the at least one buffer.

2. The method as claimed in claim 1, wherein the setting the transfer threshold based on expected delays in the communications network comprises:
receiving an indication of expected network delay; and
setting the transfer threshold based upon the received indication.

3. The method as claimed in claim 2, wherein the setting the transfer threshold based upon the received indication comprises setting the transfer threshold to be an amount of data corresponding to a video content playback duration at least equal to the expected network delay.

4. The method as claimed in claim 2, wherein the receiving the indication comprises receiving a parameter representative of the expected network delay.

5. The method as claimed in claim 4, wherein the video content is delivered over a path through the communications network, and wherein the parameter is representative of the expected network delay over the path.

6. The method as claimed in claim 4, wherein the parameter is representative of an expected network transmission delay.

7. The method as claimed in claim 6, wherein the parameter is also representative of an expected recovery delay from a network resource failure.

8. The method as claimed in claim 2, wherein the receiving the indication of expected network delay comprises receiving a first parameter representative of an expected network transmission delay and a second parameter representative of the expected network transmission delay and an expected recovery delay.

9. The method as claimed in claim 8, wherein the setting the transfer threshold based upon the received indication comprises setting the transfer threshold based on at least one of the first and second parameters.

10. The method as claimed in claim 2, wherein the receiving the indication of the expected network delay further comprises receiving a parameter representative of network packet loss and wherein the method further comprises:
adjusting the transfer threshold according to the received packet loss parameter.

11. The method as claimed in claim 2, further comprising:
receiving an updated indication of the expected network delay; and
updating the transfer threshold according to the updated indication.

12. The method as claimed in claim 2, wherein the at least one buffer comprises a client buffer at an end user.

13. The method as claimed in claim 2, wherein the at least one buffer comprises a proxy server buffer in the communications network.

14. A method for controlling streaming of video content delivered over a communications network, comprising:
receiving a request from a network user for streamed video content; and
sending an indication of expected network delays to at least one network element involved in delivery of the video content, wherein the at least one network element comprises a buffer.

15. The method as claimed in claim 14, further comprising establishing a path from an end user to a video server hosting the video content;
establishing a parameter representative of the expected network delays over the established path; and
sending the parameter to the at least one network element, wherein the at least one network element is comprised within the established network path.

16. The method as claimed in claim 14, wherein the network element comprises a client device at an end user.

17. The method as claimed in claim 14, wherein the network element comprises a proxy server.

18. A non-transitory computer readable storage medium containing instructions, which when executed by a processor, causes the processor to perform operations to control streaming of video content delivered over a communications network, comprising:
setting a transfer threshold of at least one buffer involved in delivery of the streamed video content based upon expected delays in the communications network;
wherein the transfer threshold comprises a minimum amount of data be contained in the at least one buffer before data is forwarded from the at least one buffer.

19. An apparatus for controlling streaming of video content delivered over a communications network, comprising:
a setting unit configured to set a transfer threshold of at least one buffer involved in delivery of the streamed video content based upon expected delays in the communications network;
wherein the transfer threshold comprises a minimum amount of data to be contained in the at least one buffer before data is forwarded from the at least one buffer.

20. The apparatus as claimed in claim 19, wherein the setting unit comprises:
a receiving unit configured to receive an indication of expected network delay; and
a threshold unit configured to set the transfer threshold based upon the received indication.

21. The apparatus as claimed in claim 19, wherein the setting unit further comprises:
an adjusting unit configured to adjust the transfer threshold according to a received packet loss parameter.

22. The apparatus as claimed in claim 19, wherein the setting unit further comprises:
an updating unit configured to update the transfer threshold according to a received updated indication of the expected network delay.

23. A non-transitory computer readable storage medium containing instructions, which when executed by a processor, causes the processor to perform operations to control streaming of video content delivered over a communications network comprising:
receiving a request from a network user for streamed video content; and
sending an indication of expected network delays to at least one network element involved in delivery of the video content, wherein the at least one network element comprises a buffer.

24. An apparatus to operate as a network manager for controlling streaming of video content delivered over a communications network, the apparatus comprising:
a processor and a non-transitory computer readable storage medium, the non-transitory computer readable storage medium containing instructions, which when executed by the processor, causes the apparatus to:
receive a request from a network user for streamed video content; and
send an indication of expected network delays to at least one network element involved in delivery of the video content, wherein the at least one network element comprises a buffer.
